(19) United States
(12) Patent Application Publication
(10) Pub. No.: US 2024/0089918 A1
(43) Pub. Date: Mar. 14, 2024

(54) PAGING COLLISION AVOIDANCE BY UE COMPRISING PLURALITY OF RAT NETWORKS AND SIMS IN CELLULAR NETWORK

(71) Applicant: Samsung Electronics Co., Ltd., Suwon-si, Gyeonggi-do (KR)

(72) Inventors: Vinay Kumar SHRIVASTAVA, Bangalore (IN); Sangyeob JUNG, Suwon-si (KR)

(21) Appl. No.: 18/261,084

(22) PCT Filed: Jan. 13, 2022
(86) PCT No.: PCT/KR2022/000644

§ 371 Date: Jul. 11, 2023

(30) Foreign Application Priority Data
Jan. 13, 2021 (IN) 202141001703
Jan. 21, 2021 (IN) 202141002963
Dec. 28, 2021 (IN) 202141001703

(51) Int. Cl. H04W 68/02; H04W 48/18; H04W 74/08; H04W 76/28

(52) U.S. Cl. CPC H04W 68/02; H04W 48/18; H04W 74/0816; H04W 76/28

(57) ABSTRACT

The present disclosure relates to a pre-5th generation (5G) or 5G communication system to be provided for supporting higher data rates beyond 4th generation (4G) communication system such as long term evolution (LTE). Embodiments herein provide a method for paging collision avoidance. The method includes detecting a potential paging collision between a first RAT network and a second RAT network, wherein the first RAT network is associated with a first SIM and the second RAT network is associated with a second SIM, determining and selecting one of the first RAT network and the second RAT network for avoiding the paging collision based on a paging collision avoidance criteria, and sending a signaling message to one of the selected first RAT network and the selected second RAT network to avoid the paging collision between the first RAT network and the second RAT network.

### TECHNICAL FIELD

The present invention relates to a wireless cellular network, and more specifically related to a method and a system for paging collision avoidance for Multiple-Radio Access technology (Multi-RAT) Multiple Subscriber Identity Module User Equipment's (Multi-SIM UEs). This application is based on and derives the benefit of Indian Provisional Application 202141001703 filed on 13 Jan., 2021 and Indian Provisional Application 202141002963 filed on 21 Jan., 2021, the contents of which are incorporated herein by reference.

### BACKGROUND ART

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

In general, due to popularity of a Multiple Subscriber Identity Module (Multi-SIM) devices (e.g., Multi-SIM UEs) that host more than one SIM to have the facility to connect to two or more different networks in order to avail different data plans, have user profiles like home and office, increased connectivity/reliability with multiple connections etc. There is a potential issue related to a paging collision on these multiple SIMs when their paging occasions overlap. When the paging collision happens, there is a potential loss of call reception on at least one of the networks and is drastic from user experience perspective. In certain scenarios, the paging collision can as well be systematic i.e. page configuration parameters match such that every time it leads to collision and loss of paging at least to one of the network on each paging cycle. The two or more networks can belong to same or different Radio Access Technology (RATs) (e.g. 4G or 5G or a combination 4G and 5G).

FIG. 1 illustrates a paging collision between two SIMs in a UE (100), according to prior art. Referring to the FIG. 1, at S102a, S104a, and S106a, the second RAT network apparatus (200b) sends the paging to the UE (100), respectively. At S102b, S104b, and S106b, the first RAT network apparatus (200a) sends the paging to the UE (100), respectively, but is not received. Due to paging collision, the UE (100) is not able to receive paging on the second RAT network apparatus (200b) or the first RAT network apparatus (200a). This results in leading the resource wastage and reducing the user experience.

Thus, it is desired to address the above mentioned disadvantages or other shortcomings or at least provide a useful alternative.

### DISCLOSURE OF INVENTION

### Technical Problem

The principal object of the embodiments herein is to provide a method and a wireless cellular network for paging collision avoidance for Multiple-Radio Access technology (Multi-RAT) Multiple Subscriber Identity Module User Equipments (Multi-SIM UEs). This results in avoiding the resource wastage and increasing the user experience.

Another object of the embodiments herein is to provide paging collision avoidance support for the UEs Multi-SIM UEs. This results in leading the resource wastage and reducing the user experience. Based on the proposed method, the UE selects the network with RAT which has better channel conditions so as to ensure the paging collision procedure is performed more reliably.

### Solution to Problem

Accordingly, the embodiment herein is to disclose a method for paging collision avoidance by a UE comprising a plurality of RAT networks and subscriber identity modules (SIMs) in a wireless cellular network. The method includes detecting, by the UE, a potential paging collision between a first RAT network of the plurality of RAT networks and a second RAT network of the plurality of RAT networks. The first RAT network is associated with a first SIM of the plurality of SIMs and the second RAT network is associated with a second SIM of the plurality of SIMs. Further, the method includes determining and selecting, by the UE, one of the first RAT network and the second RAT network for avoiding the paging collision based on paging collision avoidance criteria. Further, the method includes sending, by the UE, a signaling message to one of the selected first RAT network and the selected second RAT network to avoid the paging collision between the first RAT network and the second RAT network.

In an embodiment, the paging collision avoidance criteria comprises at least one of a preferred RAT network, channel conditions of the first RAT network and the second RAT network, a Discontinuous Reception (DRX) cycle length of the first RAT network and the second RAT network, a Radio Resource Control (RRC) state of the UE, a concurrent service support at the UE, a scheduling pattern for selecting the RATNW, the RAT network associated with the first SIM, a battery power level at the UE, a target alignment of a paging occasion (PO) on the first RAT network and the second RAT network, RAT configured by the first RAT network and the second RAT network, a RAT preferred by a user, a RAT specified by standards specification based on information associated with the paging collision avoidance.

In an embodiment, the method includes detecting, by the UE, whether a response from one of the selected first RAT network and the selected second RAT network for paging collision avoidance is received. Further, the method includes determining, by the UE, whether at least one of a maximum number of attempts of sending signaling message for the paging collision avoidance without response is reached and a timer for the paging collision avoidance is expired in response to detecting that the response from one of the selected first RAT network and the selected second RAT network for paging collision avoidance is not received. Further, the method includes reattempting the sending of signaling message for the paging collision avoidance based on at least one of the maximum number of attempts for the paging collision avoidance without response and the timer for the paging collision avoidance in response to determining that at least one of the maximum number of attempts for the paging collision avoidance without response is not reached and the timer for the paging collision avoidance is not expired. Further, the method includes abandoning the paging collision avoidance to one of the selected first RAT network and the selected second RAT network and pursuing another paging collision avoidance to one of the non-selected first RAT network and a non-selected second RAT network in response to determining that at least one of the maximum number of attempts of sending signaling message for the paging collision avoidance without response is reached and the timer for the paging collision avoidance is expired.

In an embodiment, the signaling message to the selected RAT network is a Mobility Registration Update (MRU) message when one of the selected first network and the selected second network is New Radio (NR) and a Tracking Area Update (TAU) message including a requested offset when one of the selected first network and the selected second network is LTE network.

In an embodiment, the response comprises one of a GUTI reassignment when one of the selected first network and the selected second network is a New Radio (NR) network and an accepted offset for an IMSI when one of the selected first network and the selected second network is a LTE network.

In an embodiment, the method includes receiving, by the UE, at least one of a system information block (SIB) message, a Radio Resource Control (RRC) signaling message, a Non Access Stratum (NAS) signaling message and a paging configuration from one of the selected first RAT network and the selected second RAT network. The at least one of the SIB message, the RRC signaling message, the NAS signaling message and the paging configuration comprises at least one of the maximum number of attempts of sending a signaling message for the paging collision avoidance without response and the timer for the paging collision avoidance.

In an embodiment, the RRC signalling message comprises at least one of a RRC release message, a RRC release with suspend configuration message, a RRC release with redirection message, a RRC resume reject message, a handover command message, and a RRC reconfiguration message,

In an embodiment, a scope of the paging collision avoidance is determined based on at least one of a cell wide with cell specific SIB, an area wide with area specific SIB, and a public land mobile network (PLMN) wide with a NAS signalling message.

In an embodiment, information for the paging collision avoidance is determined based on at least one parameter, wherein the at least one parameter comprises at least one of a RATs of the multiple SIMs, a number of SIMs, a preferred RAT for paging collision avoidance, a number of Radio Frequency Chains supported, and number of transmission (TX) chains supported.

In an embodiment, the method includes configuring, by the UE, at least one of the numbers of attempts of sending the signaling message for the paging collision avoidance request without response and the timer for paging collision avoidance request.

Accordingly, the embodiment herein is to disclose a UE for paging collision avoidance in a wireless cellular network. The UE includes a plurality of RAT networks and SIMs, a memory storing information about the plurality of RAT networks and the SIMS, a processor, and a paging collision avoidance controller. The paging collision avoidance controller is communicatively coupled to the memory and the processor. The paging collision avoidance controller is configured to detect a potential paging collision between a first RAT network of the plurality of RAT networks and a second RAT network of the plurality of RAT networks. The first RAT network is associated with a first SIM of the plurality of SIMs and the second RAT network is associated with a second SIM of the plurality of SIMs. Further, the paging collision avoidance controller is configured to determine and select one of the first RAT network and the second RAT network for avoiding the paging collision based on a paging collision avoidance criteria. Further, the paging collision avoidance controller is configured to send a signaling message to one of the selected first RAT network and the selected second RAT network to avoid the paging collision between the first RAT network and the second RAT network.

Accordingly, the embodiment herein is to disclose a method for dynamic multiple Transmission-Reception (Tx-Rx) capability adaptation for multi universal subscriber identity module (MUSIM) operation by a UE comprising a plurality of RAT networks and SIMs in a wireless cellular network. The method includes sending, by the UE, a first message comprising UE capability information for the multiple Tx-Rx to at least one of a first RAT network apparatus and a second RAT network apparatus. The first RAT network apparatus is associated with a first SIM of the plurality of SIMs and the second RAT network apparatus is associated with a second SIM of the plurality of SIMs. Further, the method includes determining, by the UE, at least one Tx-Rx from multiple Tx-Rx to be adopted by the UE for the MUSIM operation based on a plurality of parameters. Further, the method includes adapting, by the UE, the at least one Tx/Rx for the MUSIM operation. Further, the method includes sending, by the UE, a second message comprising information about the at least one adopted Tx-Rx for at least one of the MUSIM operation, a carrier aggregation operation, a dual connectivity operation to the second RAT network apparatus. Further, a secondary cell (SCell) or Secondary Cell Group (SCG) can be released, added, activated or deactivated.

In an embodiment, sending, by the UE, the first message comprising the UE capability information for the multiple Tx-Rx to the first RAT network apparatus and the second RAT network apparatus includes receiving, by the UE, a capability enquiry message from at least one of the first RAT network apparatus and the second RAT network apparatus and sending, by the UE, the first message comprising the UE capability information for the multiple Tx-Rx to at least one of the first RAT network apparatus and the second RAT network apparatus.

In an embodiment, sending, by the UE, the first message comprising the UE capability information for the multiple Tx-Rx to the first RAT network apparatus and the second RAT network apparatus includes detecting, by the UE, at least one of an initiation of the MUSIM operation, a change in the Tx-Rx capability of the UE, a change in applicability of the Tx-Rx capability across the plurality of RAT networks, and a termination of the MUSIM operation, and sending, by the UE, the first message and the second message comprising the UE capability information for the multiple Tx-Rx to the first RAT network apparatus and the second RAT network apparatus.

In an embodiment, the first message comprises one of a NAS message, a RRC message, a UE capability information message, and a UE assistance information message, and wherein the second message comprises one of a NAS message, a RRC message, a UE capability information message, and a UE assistance information message.

In an embodiment, the plurality of parameters comprises signal conditions of the first RAT network and the second RAT network, a critical MUSIM operation is pursed or not, a concurrent operation is pursed or not, multiple SIM operation is pursed or not, and a battery status of the UE.

In an embodiment, the plurality the MUSIM operation comprises a change of a RRC state, an initiation of a service, a termination of service and handle of at least one activity comprising a paging reception, SIB reception, and Radio resource management (RRM) measurement.

Accordingly, the embodiment herein is to disclose a method for dynamic multiple Transmission-Reception (Tx-Rx) capability adaptation for MUSIM operation by a UE comprising a plurality of RAT networks and SIMs in a wireless cellular network. The method includes receiving, by a first RAT network apparatus and a second RAT network apparatus, a first message comprising UE capability information for the multiple Tx-Rx from the UE, wherein the first RAT network apparatus is associated with a first SIM of the plurality of SIMs and the second RAT network apparatus is associated with a second SIM of the plurality of SIMs. Further, the method includes adapting, by the first RAT network apparatus, the at least one Tx-Rx for the MUSIM operation of the UE. Further, the method includes receiving, by the second RAT network apparatus, a second message comprising information about at least one adopted Tx-Rx for the MUSIM operation. Further, the method includes adapting, by the second RAT network apparatus, the at least one Tx-Rx for the at least one of the MUSIM operation, a carrier aggregation operation and a dual connectivity operation.

In an embodiment, receiving, by the first RAT network apparatus, the first message comprising the UE capability information for the multiple Tx-Rx from the UE includes sending, by the first RAT network apparatus, a capability enquiry message to the UE, and receiving, by the first RAT network apparatus, the first message comprising the UE capability information for the multiple Tx-Rx from the UE.

In an embodiment, receiving, by the second RAT network apparatus, the first message comprising the UE capability information for the multiple Tx-Rx from the UE includes sending, by the second RAT network apparatus, a capability enquiry message to the UE, and receiving, by the second RAT network apparatus, the first message comprising the UE capability information for the multiple Tx-Rx from the UE.

Accordingly, the embodiment herein is to disclose a UE for dynamic multiple Tx-Rx capability adaptation for MUSIM operation in a wireless cellular network. The UE includes a plurality of RAT networks and SIMs, a memory storing information about the plurality of RAT networks and the SIMS, a processor, and a multiple Tx-Rx capability adaptation controller. The multiple Tx-Rx capability adaptation controller is communicatively coupled to the memory and the processor. The multiple Tx-Rx capability adaptation controller is configured to send a first message comprising UE capability information for the multiple Tx-Rx to a first RAT network apparatus and a second RAT network apparatus. The first RAT network apparatus is associated with a first SIM of the plurality of SIMs and the second RAT network apparatus is associated with a second SIM of the plurality of SIMs. The multiple Tx-Rx capability adaptation controller is configured to determine at least one Tx-Rx from multiple Tx-Rx to be adopted by the UE for the MUSIM operation based on a plurality of parameters. The multiple Tx-Rx capability adaptation controller is configured to adapt the at least one Tx-Rx for the MUSIM operation. Further, the multiple Tx-Rx capability adaptation controller is configured to send a second message comprising information about the at least one adopted Tx-Rx for the MUSIM operation to the second RAT network apparatus.

Accordingly, the embodiment herein is to disclose a wireless cellular network for dynamic multiple Tx-Rx capability adaptation for MUSIM operation. The wireless cellular network includes a UE comprising a plurality of RAT networks and SIMs, and a first RAT network apparatus connected to the UE. The first RAT network apparatus includes a memory storing information about the plurality of RAT networks and the SIMS, a processor, and a multiple Tx-Rx capability adaptation controller. The multiple Tx-Rx capability adaptation controller is communicatively coupled to the memory and the processor. The multiple Tx-Rx capability adaptation controller is configured to receive a first message comprising UE capability information for the multiple Tx-Rx from the UE. The first RAT network apparatus is associated with a first SIM of the plurality of SIMs and the second RAT network apparatus is associated with a second SIM of the plurality of SIMs. The multiple Tx-Rx capability adaptation controller adapts the at least one Tx-Rx for the MUSIM operation of the UE. Further, the wireless cellular network includes a second RAT network apparatus connected to the UE. The second RAT network apparatus includes a memory storing information about the plurality of RAT networks and the SIMS, a processor, and a multiple Tx-Rx capability adaptation controller. The multiple Tx-Rx capability adaptation controller is communicatively coupled to the memory and the processor. The multiple Tx-Rx capability adaptation controller is configured to receive a second message comprising information about at least one adopted Tx-Rx for the MUSIM operation and adapt the at least one Tx-Rx for the MUSIM operation, a carrier aggregation and a dual connectivity operation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

According to the disclosure, there is improvements in and relating to a paging collision avoidance by user equipment (UE) comprising a plurality of radio access technology (RAT) networks and subscriber identity modules (SIMs) in a wireless communication system.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 illustrates a paging collision between two SIMs in a UE, according to prior art;

FIG. 2 illustrates an overview of a wireless network for paging collision avoidance, according to an embodiment as disclosed herein;

FIG. 3 shows various hardware components of a UE, according to an embodiment as disclosed herein;

FIG. 4 shows various hardware components of a first RAT network apparatus, according to an embodiment as disclosed herein;

FIG. 5 shows various hardware components of a second RAT network apparatus, according to an embodiment as disclosed herein;

FIG. 6a is an example sequence diagram illustrating a paging collision avoidance by selecting a RAT network apparatus, wherein the selected RAT network apparatus is a NR apparatus, according to an embodiment as disclosed herein;

FIG. 6b is an example sequence diagram illustrating a paging collision avoidance by selecting a RAT network apparatus, wherein the selected RAT network apparatus is a LTE apparatus, according to an embodiment as disclosed herein;

FIG. 7 is a flow chart illustrating a method, implemented by the UE, for paging collision avoidance, according to an embodiment as disclosed herein;

FIG. 8 is a flow chart illustrating a method, implemented by the UE, for dynamic multiple Tx-Rx capability adaptation for a MUSIM operation, according to an embodiment as disclosed herein;

FIG. 9 is a flow chart illustrating a method, implemented by the first RAT network apparatus and the second RAT network apparatus, for dynamic multiple Tx-Rx capability adaptation for the MUSIM operation, according to an embodiment as disclosed herein; and

FIG. 10 is a sequence flow diagram illustrating a method for dynamic multiple Tx-Rx capability adaptation for the MUSIM operation, according to an embodiment as disclosed herein.

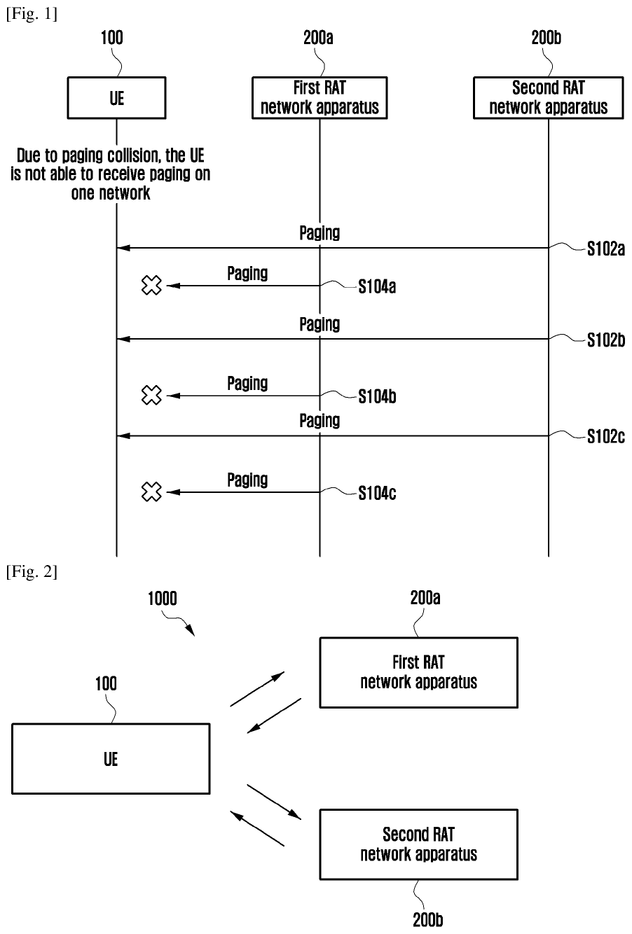

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for paging collision avoidance by a UE comprising a plurality of RAT networks and SIMs in a wireless cellular network. The method includes detecting, by the UE, a potential paging collision between a first RAT network of the plurality of RAT networks and a second RAT network of the plurality of RAT networks. The first RAT network is associated with a first SIM of the plurality of SIMs and the second RAT network is associated with a second SIM of the plurality of SIMs. Further, the method includes determining and selecting, by the UE, one of the first RAT network and the second RAT network for avoiding the paging collision based on paging collision avoidance criteria. Further, the method includes sending, by the UE, a signaling message to one of the selected first RAT network and the selected second RAT network to avoid the paging collision between the first RAT network and the second RAT network.

The proposed method can be used for paging collision avoidance for the Multi-RAT Multi-SIM UEs in the wireless cellular networks without wasting the resource and increasing the user experience. The proposed method can be used to provide the paging collision avoidance support for the Multi-SIM UEs. Based on the proposed method, the UE selects the network with RAT which has better channel conditions so as to ensure the paging collision procedure is performed more reliably.

Referring now to the drawings and more particularly to FIGS. 2 through 10 where similar reference characters denote corresponding features consistently throughout the figures, there are shown preferred embodiments.

FIG. 2 illustrates an overview of a wireless cellular network (1000) for paging collision avoidance, according to an embodiment as disclosed herein. In an embodiment, the wireless cellular network (1000) includes a UE (100), a first RAT network apparatus (200a) and a second RAT network apparatus (200b). The wireless cellular network (1000) can be, for example, but not limited to a 5G network, a 6G network and an O-RAN network. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device.

The UE (100) is configured to detect a potential paging collision between a first RAT network (170a) (as shown in the FIG. 3) of the plurality of RAT networks (170) (as shown in the FIG. 3) and a second RAT network (170b) (as shown in the FIG. 3) of the plurality of RAT networks (170). The first RAT network (170a) is associated with the first SIM (160a) (as shown in the FIG. 3) of the plurality of SIMs (160) (as shown in the FIG. 3) and the second RAT network (170b) is associated with the second SIM (160b) (as shown in the FIG. 3) of the plurality of SIMs (160). Further, the UE (100) is configured to determine and select one of the first RAT network (170a) and the second RAT network (170b) for avoiding the paging collision based on a paging collision avoidance criteria.

The paging collision avoidance criteria can be, for example, but not limited to a preferred RAT network, channel conditions of the first RAT network (170a) and the second RAT network (170b), a DRX cycle length of the first RAT network (170a) and the second RAT network (170b), a RRC state of the UE (100), a concurrent service support at the UE (100), a scheduling pattern for selecting the RAT/NW, the RAT network (170) associated with the first SIM (160a), a battery power level at the UE (100), a target alignment of a PO on the first RAT network (170a) and the second RAT network (170b), the RAT (170) configured by a network, the RAT (170) preferred by a user, and the RAT (170) specified by standards specification based on information associated with the paging collision avoidance.

In order to avoid the paging collision between the first RAT network (170a) and the second RAT network (170b), the UE (100) is configured to send a signalling message to one of the selected first RAT network (170a) and the selected second RAT network (170b). In an embodiment, the signalling message to the selected RAT network is a MRU message when one of the selected first network and the selected second network is a NR network and a TAU message including a requested offset when one of the selected first network and the selected second network is LTE network.

Further, the UE (100) is configured to detect whether a response from one of the selected first RAT network and the selected second RAT network for the paging collision avoidance is received. The response comprises one of the GUTI reassignment when the selected first RAT network is a NR network apparatus and an accepted offset for an IMSI when the selected first RAT network is a LTE network apparatus.

In response to detecting that the response from one of the first RAT network and the second RAT network for the paging collision avoidance is not received, the UE (100) is configured to determine whether at least one of the maximum number of attempts of sending the signalling message for the paging collision avoidance without response is reached and the timer for the paging collision avoidance is expired. In response to determining that at least one of the maximum number of attempts for the paging collision avoidance without response is not reached and the timer for the paging collision avoidance is not expired, the UE (100) is configured to reattempt the sending of signalling message for paging collision avoidance based on at least one of the maximum number of attempts for the paging collision avoidance without response and the timer for the paging collision avoidance. In response to determining that at least one of the maximum number of attempts of sending signalling message for the paging collision avoidance without response is reached and the timer for the paging collision avoidance is expired, the UE (100) is configured to abandon the paging collision avoidance to the one of the selected first RAT network and the selected second RAT network and pursuing another paging collision avoidance to one of the non-selected first RAT network and a non-selected second RAT network.

Further, the UE (100) is configured to receive at least one of a SIB message, a RRC signalling message, a NAS signalling message and a paging configuration from one of the selected first RAT network and the selected second RAT network. The at least one of the SIB message, the RRC signalling message, the NAS signalling message and the paging configuration comprises at least one of the maximum number of attempts of sending the signalling message for the paging collision avoidance without response and the timer for the paging collision avoidance. The RRC signalling message can be, for example, but not limited to a RRC release message, a RRC release with suspend configuration message, a RRC release with redirection message, a RRC resume reject message, a handover command message, and a RRC reconfiguration message.

Further, a scope of the paging collision avoidance is determined based on at least one of a cell wide with cell specific SIB, an area wide with area specific SIB, and a PLMN wide with a NAS signalling message. Further, information for the paging collision avoidance is determined based on at least one parameter. The at least one parameter can be, for example, but not limited to the RATs (170) of the multiple SIMs (160), a number of SIMs (160), a preferred RAT for paging collision avoidance, a number of Radio Frequency Chains and a number of transmission chains.

Further, the UE (100) configures at least one of the maximum number of attempts of sending the signalling message for the paging collision avoidance request without response and the timer for paging collision avoidance.

Further, the UE (100) is configured to send a first message comprising UE capability information for the multiple Tx-Rx to the first RAT network apparatus (200a) and the second RAT network apparatus (200b). In an embodiment, the UE (100) is configured to receive the capability enquiry message from the first RAT network apparatus (200a) and the second RAT network apparatus (200b) and send the first message comprising the UE capability information for the multiple Tx-Rx to the first RAT network apparatus (200a) and the second RAT apparatus (200b). In another embodiment, the UE (100) is configured to detect at least one of an initiation of the MUSIM operation, a change in the Tx-Rx capability of the UE (100), a change in applicability of the Tx-Rx capability across the plurality of RAT networks (170), and a termination of the MUSIM operation. Further, the UE (100) is configured to send the second message comprising the UE capability information for the multiple Tx-Rx to the at least one of the first RAT network apparatus (200a) and the second RAT network apparatus (200b).

The first message can be, for example, but not limited to a NAS message, a RRC message, a UE capability information message, and a UE assistance information message. The first RAT network apparatus (200a) is associated with the first SIM of the plurality of SIMs (160) and the second RAT network apparatus (200b) is associated with the second SIM of the plurality of SIMs (200b). Further, the UE (100) is configured to determine the Tx-Rx from multiple Tx-Rx to be adopted by the UE (100) for the MUSIM operation based on a plurality of parameters. The plurality of parameters can be, for example, but not limited to signal conditions of the first RAT network apparatus (200a) and the second RAT network apparatus (200b), a critical MUSIM operation pursed or not, a concurrent operation pursed or not, multiple SIM operation pursed or not, and a battery status of the UE (100). Further, the UE (100) is configured to adapt the Tx-Rx for the MUSIM operation. The plurality the MUSIM operation comprises a change of a RRC state, an initiation of a service, a termination of service and handle of at least one activity comprising a paging reception, SIB reception, and RRM measurement. Further, the UE (100) is configured to send a second message comprising information about the at least one adopted Tx-Rx for the MUSIM operation to the second RAT network apparatus (200b). The second message can be, for example, but not limited to the NAS message, the RRC message, the UE capability information message, and the UE assistance information message. The second RAT network apparatus (200b) adapts the at least one Tx-Rx for the MUSIM operation, a carrier aggregation and a dual connectivity operation. Further, a secondary cell (SCell) or Secondary Cell Group (SCG) can be released, added, activated or deactivated.

The proposed method describes the methods considering two SIMs for the illustration purpose. However, this does not limit the methods and description for multiple SIM cases e.g. where more than two SIMs are supported like 3, 4, and 5 so on. These SIMs can belong to same or different RATs e.g. 4G or 5G or a combination 4G and 5G.

In an example, a New Radio or 5G UE (NR UE) in idle/inactive mode calculates its Paging Occasion (PO) and Paging Frame (PF) based on its UE ID and N, where UE ID: 5G-S-TMSI mod 1024, and N: number of total paging frames in DRX cycle T of the UE (100). Based on the PO and PF, the UE (100) monitors PDCCH (Physical Downlink Control Channel) to read paging DCI i.e. Downlink Control Information (DCI format 1_0 with CRC scrambled by P-RNTI i.e. Paging Radio Network Terminal Identifier) and further reads the paging message. The UE (100) decides if the paging message is intended for it only after reading the actual paging message. All other UEs discard the paging message as a False Alarm. This way, a group of UEs (paging group) reads PDCCH and further paging message based on respective UE_ID and N on the same PO and PF. The PF and PO for paging are determined by the following formulae:
a. SFN for the PF is determined by:
a. (SFN+PF_offset) mod T=(T div N)*(UE_ID mod N)
b. Index (is), indicating the index of the PO is determined by:
a. i_s=floor (UE_ID/N) mod Ns
c. The following parameters are used for the calculation of PF and i_s above:
a. T: DRX cycle of the UE,
b. N: number of total paging frames in T,
c. Ns: number of paging occasions for a PF, and
d. PF_offset: offset used for PF determination,
e. UE_ID: 5G-S-TMSI mod 1024,
d. In case when the SIM belongs to LTE
a. UE_ID: IMSI mod 1024

An International Mobile Subscriber Identity (IMSI) is a permanent UE identity whereas 5G-S-TMSI is a temporary identity which can be reassigned by core network to the UE frequently e.g. possibly at every cell reselection a new 5G-S-TMSI could be reassigned.

In an example, the UE (100) performs the paging collision detection mechanism for the two SIMs. It involves both (a) paging collision detection when actual collision has already occurred and (b) potential paging collision which may occur and the UE (100) determines in advance. The two SIMs considered may belong to a LTE or a NR network e.g. there may be combination like NR+NR, NR+LTE, LTE+NR and LTE+LTE for the two SIMs used by the UE. The selection among LTE or 5G SIM for paging collision resolution: In one embodiment, when the two networks belong to different RATs like LTE and 5G, the UE (100) determines and selects one of LTE and 5G network for initiating paging collision resolution procedure. The determination is based on at least one or combination of many factors including but not limited to—
1. The UE (100) selects the LTE network for paging collision resolution as the UE_ID is based on a permanent identify IMSI (International Mobile Subscriber Identity) unlike 5G-S-TMSI used in 5G which can change frequently on cell reselection and/or NAS procedures causing in-deterministic operation for the UE (100).
2. The UE (100) selects the NR network for the paging collision resolution in order to simplify the paging collision resolution mechanism for the UE (100) and the network apparatus (200a and 200b). In an example, limiting paging resolution to new networks or new releases and not affecting legacy RATs or networks or existing commercial devices or earlier releases like LTE simplify the overall operation and limit the impacts of the changes caused by the new mechanism of paging collision resolution.
3. The UE (100) selects either LTE or NR network for paging collision resolution based on channel conditions like signal strength parameters e.g. RSRP, RSRQ, SINR, RSSI or Block Error Rate/Packet Loss Rate or Channel Quality Indicator (CQI). The UE (100) selects the network with RAT which has better channel conditions so as to ensure the paging collision procedure is performed more reliably.
4. The UE (100) selects either LTE or NR network for the paging collision resolution based on DRX cycle length i.e. paging cycle lengths used by the networks apparatus (200a and 200b). For instance, the UE (100) selects the RAT or network which has higher paging cycle length as the collision occurrences are linked with these occasions. E.g. LTE has 640 ms paging cycle and NR has 1280 ms paging cycle, the page collision at the most can happen at every 1280 ms. Alternatively, the UE (100) may select the RAT or network which has lower paging cycle length.
5. The UE (100) selects either LTE or NR network for paging collision resolution based on whether the UE state on the NR network is in an idle or an inactive RRC state. In case the UE (100) on the NR network is in the inactive state, the UE (100) prefers the NR network for paging collision resolution procedure. Alternatively, the UE (100) prefers the NR network for paging collision resolution procedure, when the UE (100) on the NR network is in the idle mode.
6. The UE (100) selects either LTE or NR network for paging collision resolution based on whether the UE (100) on the LTE or the NR network is also availing other services in the idle state or the inactive state e.g. receiving Broadcast or Multicast services like eMBMS or NR MBS. The selection of network for paging collision that supports other services like Broadcast and/or Multicast provides the UE (100) more flexibility to suitably select or modify the paging occasion which is in accordance with the other service scheduling and the UE (100) saves more power by avoiding for the UE (100) to be awake at two distant or distinct occasions for paging reception and other service reception.
7. The UE (100) selects either LTE or NR network for paging collision resolution based on whether the UE (100) on the LTE or NR network is also being served by Non-3GPP access or unlicensed access.
8. The UE (100) toggles or selects RAT/Network in Round-Robin manner or with some other scheduling pattern for initiating paging collision resolution procedure so that both the RATs/Networks are effectively equally impacted or affected.
9. The UE (100) always select the first SIM (SIM placed in first SIM slot or specified by device or user as first SIM) irrespective of LTE or NR RAT. Alternatively, the UE (100) always select the second SIM (SIM placed in second SIM slot or specified by device or user as second SIM) irrespective of LTE or NR RAT.
10. The UE (100) always select the SIM or RAT for paging collision resolution procedure which is preferred by user or configured by network or specified in specification release or informed by the UE capability message.
11. The UE (100) always select the SIM or RAT for paging collision resolution procedure which is supported by cell or network on which UE (100) is camped. For example, it is signaled or informed to the UE (100) by the system broadcast information whether cell or network supports paging collision resolution and/or facilitates paging retransmission or repetition etc.

In another embodiment, the selection of the RAT or network for paging collision resolution procedure is configured by the network apparatus (200a and 200b). The network apparatus (200a and 200b) can configure at least any one of the factors or approaches as mentioned earlier and requires the UE (100) to make this selection of LTE or NR RAT and/or first or second Network/SIM for paging collision resolution procedure. The network configuration can be signaled to the UE(s) either by broadcast signaling like system information block (SIB) message and/or dedicated RRC signaling message like RRC Reconfiguration. The network configuration can include at least one or more of the factors as specified earlier, and/or one or more approaches as discussed earlier and/or one or more paging collision avoidance solutions as discussed later.

In another embodiment, the selection of the RAT or network for paging collision resolution procedure is left to the UE implementation i.e. it is not specified in standards or not configured by the network apparatus (200a and 200b). The UE (100) can choose at least any one of the factors or approaches as mentioned earlier and makes this selection of LTE or NR RAT and/or first or second network/SIM for paging collision resolution procedure.

Preferred approach when selecting the LTE or 5G SIM: In one embodiment, when the UE (100) has selected LTE network for paging collision resolution, the UE (100) prefers or selects offset based approach for paging collision resolution on the LTE network. When the UE (100) has selected NR network for paging collision resolution, the UE (100) prefers or selects GUTI reassignment based approach for paging collision resolution on the NR network.

In one embodiment, when selecting the LTE or 5G SIM, the UE (100) prefers or selects same approach for paging collision resolution on both the LTE and 5G network. In an example, the UE (100) prefers or selects offset based approach for paging collision resolution on both the LTE and NR network.

In one embodiment, generically when the UE (100) has selected LTE or NR network for paging collision resolution, the UE (100) prefers or selects at least one of offset based approach, GUTI reassignment based approach, Alternative UE_ID based approach, MUSIM assistance based approach, network repetition based approach, the UE implementation based approach for paging collision resolution on the LTE or NR network.

For offset based approach, the UE (100) computes the offset value to the existing UE_ID that is suitable to resolve the (potential) paging collision by avoiding the overlap of PF/PO of the first SIM with that of second SIM. For alternative UE_ID, the UE (100) itself determines the updated UE_ID by adding computed offset and provides to the network. The network apparatus (200a and 200b) utilizes this UE provided UE_ID for the paging purpose. For MUSIM assistance based approach, the UE (100) itself determines the updated UE_ID by adding computed offset and provides to the network in assistance information along with other information like DRX parameters, expected paging repetition pattern or the availability information of the UE (100).

In GUTI reassignment based approach, the UE (100) triggers registration update request, Mobility registration request or any other NAS signaling and avails new GUTI assignment from the network apparatus (200a and 200b). The GUTI also includes the new UE_ID which UE (100) needs to use for paging reception purpose. For network repetition based approach, the network apparatus (200a and 200b) performs repetition or retransmission of the paging message. The network apparatus (200a and 200b) can inform the UE (100) by system information broadcast or other configuration, that it supports the network repetition approach. The UE specific implementation approach implies that the UE (100) by itself devises some strategy for paging reception across two SIMs/Networks e.g. Round Robin approach or so on.

Dual RX/Dual TX or Dual RX/Single TX capable UE: In another embodiment, the UE (100) which is capable of dual RX and/or dual TX or Dual RX/Single TX RF chains can utilize its enhanced capacity to share RX and/or TX across the two networks/RATs/SIMs in order to avoid paging collision avoidance. The UE (100) indicates it's dual or multiple RX and/or dual/multiple TX capability to the network apparatus (200a and 200b) through one of the UE capability information message, UE assistance information message, MUSIM assistance information message or any other RRC or NAs signaling message.

The sharing of RX and TX can be extended to also address the Connected-Idle, IdleConnected and Connected-Connected states for the two RATs/Networks/SIMs so that the UE (100) can as well do other operations in addition to paging reception with utilizing the dual/multiple RX and/or TX capability jointly. In another embodiment, due to sharing of the RX and/or TX, the performance quality of the UE (100) changes as compared to utilizing all the RX and/or TX for the same network/RAT. Therefore, it is proposed that the UE (100) indicates in one of the earlier mentioned RRC or NAS message about the sharing status and information how many RX/TX are shared across two SIMs, to the network apparatus (200a and 200b) so that network apparatus (200a and 200b) can adapt its transmission and/or reception parameters for the UE e.g. modulation and Coding Scheme (MCS) applied to the transmission stream when sharing status is known is adapted accordingly.

In another embodiment, the UE (100) shares the dual/multiple RX and/or TX across the two SIMs/RATs/networks such that at a time each of them avails all the RX and/or TX and resulting into the robust operation. For example, the paging reception operation will be robust for both the networks apparatus (200a and 200b), however, approaches as discussed earlier for the paging collision resolution need to be employed. The UE (100) can apply any one of afore mentioned approaches for paging collision avoidance. This is especially true in Idle-Idle mode as there is no other data reception related operations and MUSIM operations are mostly restricted for paging, SIB reception and/or measurement operation which all can be greatly benefitted with the enhanced RX and TX capability of the UE e.g. specially in lower signal conditions areas like cell edge. As utilizing multiple RX and/TX causes excessive power and at the same time improves receiver or transmitter performance e.g. dual RX has 3 dB improvement in reception performance, it needs to be judiciously be enabled in poor signaling conditions or be disabled when battery conditions are poor.

In another embodiment, the UE (100) can also time-slice or switch the RX and/or TX across the two networks to achieve parallel operations on two networks apparatus (200a and 200b).

Busy indication: In another embodiment, when the UE (100) is pursuing some priority task or service on the SIM A and UE (100) receives paging on the SIM B, the UE (100) provides the busy indication to the network (SIM B). The network apparatus (200a and 200b) provides the priorities of the tasks or services (for SIM A) and/or paging cause or priority information in the paging message (for SIM B) on order to determine whether UE (100) sends Busy indication or not based on the priority or urgency comparison. Alternatively, this is specified in the standards and/or UE by itself defines/implements the priorities of different tasks/services and determine whether it needs to send Busy indication or not. Though we describe the procedure for paging response and busy indication sending, this can be generalized to triggeringgeneration of access stratum or non-access stratum signaling like TAU (Tracking Area update), RAU (Registration Area Update) etc. and sending of the signaling message on second network (SIM B) when there is certain task/service is being supported on first network. Similar prioritization approach is employed in the invention.

In another embodiment, Busy indication is sent in response to paging on second network (SIMB) when the UE (100) is pursuing DRX sleep or measurement gaps or autonomous gaps or configured short time switching gap on the first network (SIM A)

In another embodiment, paging cause is provided only to the MUSIM capable UE and/or busy indication is sent in response to paging only by the MUSIM capable UE (100). The paging cause can include at least one of voice, data, emergency, public safety, mission critical push to talk, V2X, MBS, Messaging and/or high or low priority signaling service.

There is a potential issue in hand about how network apparatus (200a and 200b) knows when to page the UE again (and also, how other side UE knows about availability/accessibility of this UE for call retries). It is similar to case when out of coverage reason someone is not reachable and then becomes accessible again. Some of the proposed approaches to achieve this objective of informing the network about the UE busy status includes—
1. The UE (100) sends “Not Busy” indication once it becomes available i.e. priority service(s) on the SIM A are completed. UE sends RRC resume or RRC connection request message and indicates the “Not Busy” status to the network. Further, “Not Busy” indication can also be sent in NAS signaling and/or MAC signaling.
2. The UE (100) runs a timer and informs network on status on expiry of timer each time, until busy status is not changed. The timer is started when UE sends “Busy” indication first time and/or restarts every time it sends “Busy” indication. After expiry of timer, UE shares updated status (i.e. either “Busy” or “Not Busy”) to the network. The timer duration and configuration is provided by the network. Alternatively, an UE can choose or implement its own timer duration and configurations.
3. The UE (100) informs the busy period to second network after determining the potential duration during which it would be occupied with task/service/operation on first network (SIM A) and includes the same along with busy indication to the second network (SIM B).
4. The network apparatus (200a and 200b) periodically polls the UE (100) which has indicated busy indication to check the availability of the UE (100) to receive paging and/or call/data on the network (SIM B).

In an embodiment, the UE (100) receives the paging collision avoidance feature support and/or supported paging collision avoidance approach by the network indication on the cell/RAT (Radio Access Technique)/PLMN (Public Land Mobile Network) from the network apparatus (200a and 200b). This can be indicated by at least one of the following approaches:
1. System information broadcast (SIB) that may include SIB-1 and/or SIB-2 and/or new SIB and/or SIB on demand.
2. Radio Resource Control (RRC) signaling message like RRC Release, RRC Release with suspend configuration, RRC Release with redirection, RRC Resume Reject, handover command, RRC reconfiguration.
3. Non Access Stratum (NAS) signaling message.
4. In response to the UE (100) conveying paging collision indication and/or UE (100) requesting for potential paging collision avoidance.
5. In response to the UE (100) capability message conveying support for MUSIM or need for paging collision avoidance support from network.
6. Based on the NR specification release supported by the network apparatus (200a and 200b) e.g. paging collision avoidance feature is supported by release 17 network by default.

In another embodiment, the scope of the support for the paging collision avoidance and/or supported paging collision avoidance approach can be one of the cells, area, PLMN. The UE (100) derives or interprets the scope of the paging collision avoidance supported by the network apparatus (200a and 200b) on basis of the signaling utilized e.g. Cell wide with cell specific SIB, Area wide with Area specific SIB, PLMN wide with NAS signaling message etc. alternatively, scope of the paging collision avoidance support by the network apparatus (200a and 200b) is explicitly indicated in the SIB message, RRC signaling message and/or NAS signaling message.

In another embodiment, the UE (100) provides the UE capability conveying support for MUSIM and/or need for paging collision avoidance support from the network apparatus (200a and 200b) and/or supported paging collision avoidance approach or approaches by the UE (100) and/or preferred paging collision avoidance approach by the UE (100) and/or further detailed information on the MUSIM support e.g. RATs of the multiple SIMs, number of SIMs, preferred RAT for paging collision avoidance, number of RX (Radio Frequency Chains, i.e. RF chains) supported, number TX (RF chains) supported, the UE implementation approach supported for paging collision avoidance, need for paging repetition from the network, DRX and/or scheduling pattern information, alternate paging offset for Paging occasion for paging repetition.

The aforementioned information is provided by the UE (100) to the network apparatus (200a and 200b) in the UE capability information message. This could also be in response to UE capability enquiry from the network apparatus (200a and 200b) or sent by the UE (100) by itself. Alternatively, the aforementioned information is provided by the UE (100) to the network apparatus (200a and 200b) in the UE assistance information and/or any other RRC signaling and/or NAS signaling.

Further, the UE (100) may provide the aforementioned information along with the paging collision indication and/or paging collision avoidance request to the network apparatus (200a and 200b) when the UE (100) perceives a potential paging collision and/or a paging collision has occurred.

In another embodiment, the UE (100) receives the paging collision avoidance feature support by the network apparatus (200a and 200b) indication along with one or more supported approach for paging collision avoidance e.g. UE based GUTI reassignment, Alternative UE ID approach, offset based approach, MUSIM assistance information based approach, network based paging repetition approach, the UE implementation based approach and so on.

GUTI reallocation request for receiving new GUTI (thereby a new UE_ID) are as follows:
1. The UE (100) determines the potential paging collision.
2. The UE (100) triggers a GUTI reassignment request to the network apparatus (200a and 200b) though the NAS signaling, along with an optional alternative UE_ID that would cause a more suitable paging occasion.
3. The network apparatus (200a and 200b) on receiving GUTI reassignment request from the UE (100), reallocates a new GUTI to the UE (GUTI comprises of the UE_ID i.e. 5G-S-TMSI). Further, if optional alternative UE_ID is included in request message, the network apparatus (200a and 200b) allocates GUTI accordingly to provide the same UE_ID or another suitable UE_ID to the UE (100).
4. On receiving new GUTI and thereby UE_ID, the UE (100) alters the paging reception operation with the new paging occasion in accordance with the UE_ID.

Alternative UE_ID based approaches are as follows:
1. The UE (100) determines that the potential paging collision.
2. The UE (100) computes alternative UE_ID that would cause the paging conflict to be avoided.
3. The UE (100) sends the alternative UE_ID to the network and receives a confirmation or a new allocation message for UE_ID.
4. The UE (100) alters the paging reception operation with the new paging occasion in accordance with the UE_ID.

MUSIM assistance information is sent as a NAS signaling message to the network apparatus (200a and 200b) along with alternative UE_ID or scheduling/DRX information or preferred paging occasion are as follows:
1. The UE (100) provides the alternative UE_ID for paging purpose, scheduling andor DRX configuration information and/or preferred paging occasion which UE (100) determines by itself.
2. The network apparatus (200a and 200b) devises the new paging occasion for the UE (100) based on the MUSIM assistance information it received from the UE (100). The network apparatus (200a and 200b) provides the paging occasion or UE_ID accordingly to the UE (100).

Offset information to the existing paging occasion to avail paging at new shifted occasion, below steps are as follows:
1. The UE (100) computes and determines the paging occasion and thereby, the needed offset to the existing paging occasion. The UE (100) indicates the computed offset value to the network apparatus (200a and 200b) through a NAS signaling message like MRU (mobility request Update), Registration update etc. or RRC signaling message like UE assistance message or through MAC signaling like MAC CE.
2. On receiving offset information, the network apparatus (200a and 200b) provides the paging occasion or UE_ID accordingly to the UE (100) and/or delivers paging message by applying the requested offset to the existing paging occasion and further, the UE (100) also receives the paging after applying the needed offset to the existing paging occasion.

In another embodiment, when data-InactivityTimer expires and the UE (100) could not receive RRC Release message, the UE (100) utilizes—1. Feature support indication and/or paging collision approach supported on present cell or area from the previous RRC Release if same cell or area is applicable.
2. Stored information for Feature support indication and/or paging collision approach supported for specific cell.
3. Receives the information for Feature support indication and/or paging collision approach from the SIB.
4. Receives the information for Feature support indication and/or paging collision approach from SIB on demand approach.
5. Does not apply the paging collision avoidance.

In another embodiment, the MUSIM UE (100) receives the paging collision avoidance feature support by one of the multiple networks (200a and 200b). The UE (100) selects the network apparatus (200a and 200b) for triggering paging collision avoidance when potential paging collision is determined. When two or more networks apparatus (200a and 200b) among the multiple networks support paging collision avoidance feature, the UE (100) selects one of them on basis of factors that include at least one of the following:
1. Which SIM belongs to preferred RAT for paging collision avoidance e.g. NR or LTE.
2. It is determined or decided by the UE (100) that which RAT is preferred by the UE (100) for paging collision avoidance.
3. It is configured by network that which RAT is preferred by the UE (100) for paging collision avoidance.
4. It is specified by the 3GPP standards that which RAT is preferred by the UE (100) for paging collision avoidance.
5. Which paging collision avoidance approach is supported by respective SIMs, signal strengths, location, corporate or personal plan, power saving performance, round-robin approach for paging collision avoidance across SIMs, depending on whether Idle and/or Inactive state of the RAT/network on the SIMs, support for MBS (Multicast Broadcast service) and/or eMBMS (Evolved Multimedia Broadcast Multicast service) on one or more SIMs etc.

In another embodiment, the UE (100) reattempts for the paging collision avoidance request on first network (200a) when there is no confirmation is received and/or no new assignment of new GUTI or UE ID from the first network (200a). The network apparatus (200a and 200b) can configure the maximum number of attempts and/or time duration until the UE (100) can pursue with the paging collision avoidance. This configuration is provided on system information block and/or along with paging configuration information to the UE (100). On hitting the maximum number of attempts for paging collision avoidance request and/or the time duration over (i.e. a specified timer may be configured and is expired), the UE (100) abandons paging collision avoidance signaling to the first network (SIM A) and pursues paging collision avoidance signaling to the second network (SIM B).

In another embodiment, the UE (100) abandons paging collision avoidance request to the first network (SIM A) and pursues paging collision avoidance request to the second network (SIM B), when the UE (100) again hits the paging collision or will potentially have the paging collision with the newly provided GUTI or UE ID or paging configuration.

In another embodiment, the UE (100) enquires to one or more of the networks that are associated with Multiple SIMs, for the paging collision avoidance support in accordance to the earlier mentioned factors.

FIG. 3 shows various hardware components of the UE (100), according to an embodiment as disclosed herein. In an embodiment, the UE (100) includes a processor (110), a communicator (120), a memory (130), a paging collision avoidance controller (140), a multiple Tx-Rx capability adaptation controller (150), the plurality of SIMs (160) and the plurality of RAT networks (170). The processor (110) is coupled with the communicator (120), the memory (130), the paging collision avoidance controller (140), the multiple Tx-Rx capability adaptation controller (150), the plurality of SIMs (160) and the plurality of RAT networks (170). The memory (130) stores the information about the plurality of RAT networks (170) and the SIMS (160).

The paging collision avoidance controller (140) is configured to detect the potential paging collision between the first RAT network (170a) and the second RAT network (170b). The first RAT network (170a) is associated with the first SIM (160a) and the second RAT network (170b) is associated with the second SIM (160b). Further, the paging collision avoidance controller (140) is configured to determine and select one of the first RAT network (170a) and the second RAT network (170b) for avoiding the paging collision based on the paging collision avoidance criteria.

In order to avoid the paging collision between the first RAT network (170a) and the second RAT network (170b), the paging collision avoidance controller (140) is configured to send the signalling message to one of the selected first RAT network (170a) and the selected second RAT network (170b).

Further, the paging collision avoidance controller (140) is configured to detect whether the response from one of the selected first RAT network and the selected second RAT network for paging collision avoidance is received. In response to detecting that the response from one of the selected first RAT network and the selected second RAT network for paging collision avoidance is not received, the paging collision avoidance controller (140) is configured to determine whether at least one of the maximum number of attempts of sending signalling message for the paging collision avoidance without response is reached and the timer for the paging collision avoidance is expired.

In response to determining that at least one of the maximum number of attempts for the paging collision avoidance without response is not reached and the timer for the paging collision avoidance is not expired, the paging collision avoidance controller (140) is configured to reattempt the sending of signalling message for paging collision avoidance based on at least one of the number of attempts for the paging collision avoidance without response and the timer for the paging collision avoidance. In response to determining that at least one of the maximum number of attempts of sending signalling message for the paging collision avoidance without response is reached and the timer for the paging collision avoidance is expired, the paging collision avoidance controller (140) is configured to abandon the paging collision avoidance to one of the selected first RAT network and the selected second RAT network and pursuing another paging collision avoidance to one of the non-selected first RAT network and the non-selected second RAT network.

Further, the paging collision avoidance controller (140) is configured to receive the at least one of the SIB message, the RRC signalling message, the NAS signalling message and the paging configuration from one of the selected first RAT network and the selected second RAT network. The at least one of the SIB message, the RRC signalling message, the NAS signalling message and the paging configuration comprises at least one of the maximum number of attempts of sending the signalling message for the paging collision avoidance without response and the timer for the paging collision avoidance.

Further, the paging collision avoidance controller (140) configures at least one of the maximum number of attempts of sending the signalling message for the paging collision avoidance without response and the timer for paging collision avoidance.

Further, the multiple Tx-Rx capability adaptation controller (150) is configured to send the first message comprising UE capability information for the multiple Tx-Rx to the first RAT network apparatus (200a) and the second RAT network apparatus (200b). In an embodiment, the multiple Tx-Rx capability adaptation controller (150) is configured to receive the capability enquiry message from the first RAT network apparatus (200a) and the second RAT network apparatus (200b) and send the first message comprising the UE capability information for the multiple Tx-Rx to the first RAT network apparatus (200a) and the second RAT apparatus (200b). In another embodiment, the multiple Tx-Rx capability adaptation controller (150) is configured to detect at least one of the initiation of the MUSIM operation, the change in the Tx-Rx capability of the UE (100), the change in applicability of the Tx-Rx capability across the plurality of RAT networks (170), and the termination of the MUSIM operation. Further, the multiple Tx-Rx capability adaptation controller (150) is configured to send the first message comprising the UE capability information for the multiple Tx-Rx to the first RAT network apparatus (200a) and the second RAT network apparatus (200b).

Further, the multiple Tx-Rx capability adaptation controller (150) is configured to determine the Tx-Rx from multiple Tx-Rx to be adopted by the UE (100) for the MUSIM operation based on a plurality of parameters. Further, the multiple Tx-Rx capability adaptation controller (150) is configured to adapt the Tx-Rx for the MUSIM operation. Further, the multiple Tx-Rx capability adaptation controller (150) is configured to send the second message comprising information about the at least one adopted Tx-Rx for the MUSIM operation to the second RAT network apparatus (200b).

The paging collision avoidance controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The multiple Tx-Rx capability adaptation controller (150) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

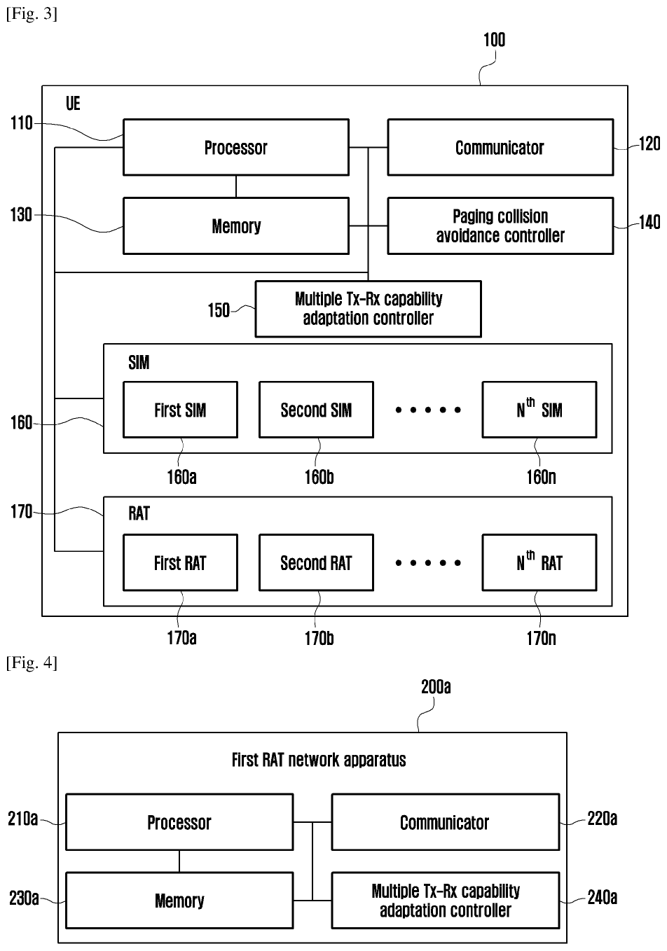

FIG. 4 shows various hardware components of the first RAT network apparatus (200a), according to an embodiment as disclosed herein. In an embodiment, the first RAT network apparatus (200a) includes a processor (210a), a communicator (220a), a memory (230a) and a multiple Tx-Rx capability adaptation controller (240a). The processor (210a) is coupled with the communicator (220a), the memory (230a) and the multiple Tx-Rx capability adaptation controller (240a).

The multiple Tx-Rx capability adaptation controller (240a) is configured to receive the first message comprising the UE capability information for the multiple Tx-Rx from the UE (100) and adapt the at least one Tx-Rx for the MUSIM operation of the UE (100).

The multiple Tx-Rx capability adaptation controller (240a) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210a) is configured to execute instructions stored in the memory (230a) and to perform various processes. The communicator (220a) is configured for communicating internally between internal hardware components and with external devices via one or more networks. The memory (230a) also stores instructions to be executed by the processor (210a). The memory (230a) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230a) may, in some examples, be considered a non-transitory storage medium. The term “non-transitory” may indicate that the storage medium is not embodied in a carrier wave or a propagated signal. However, the term “non-transitory” should not be interpreted that the memory (230a) is non-movable. In certain examples, a non-transitory storage medium may store data that can, over time, change (e.g., in Random Access Memory (RAM) or cache).

Although the FIG. 4 shows various hardware components of the first RAT network apparatus (200a) but it is to be understood that other embodiments are not limited thereon. In other embodiments, the first RAT network apparatus (200a) may include less or more number of components. Further, the labels or names of the components are used only for illustrative purpose and does not limit the scope of the invention. One or more components can be combined together to perform same or substantially similar function in the first RAT network apparatus (200a).

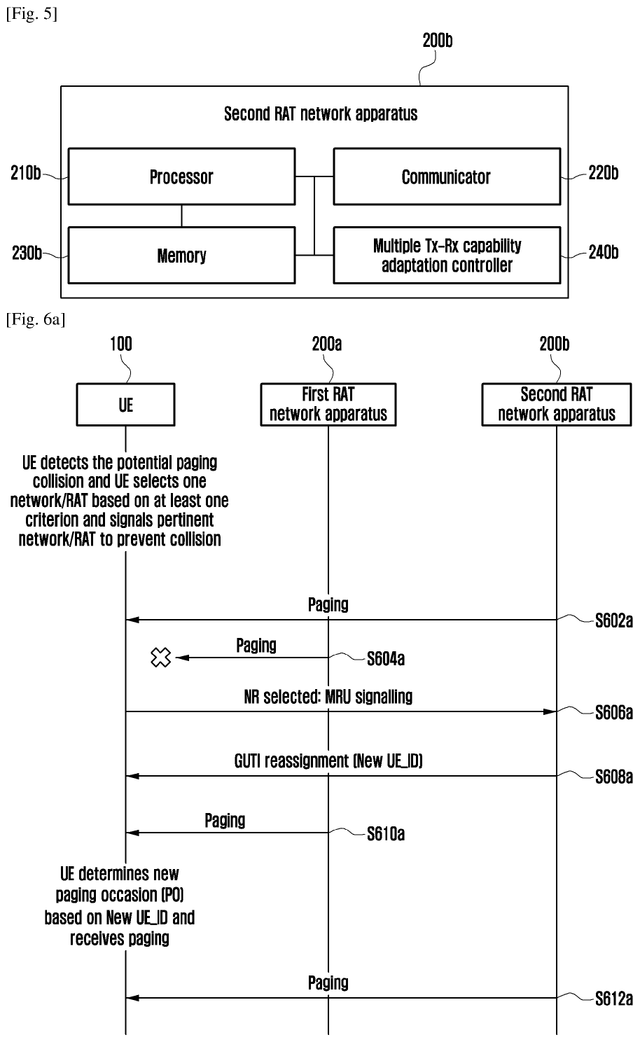

FIG. 5 shows various hardware components of the second RAT network apparatus (200b), according to an embodiment as disclosed herein. In an embodiment, the second RAT network apparatus (200b) includes a processor (210b), a communicator (220b), a memory (230b) and a multiple Tx-Rx capability adaptation controller (240b). The processor (210b) is coupled with the communicator (220b), the memory (230b) and the multiple Tx-Rx capability adaptation controller (240b).

The multiple Tx-Rx capability adaptation controller (240b) is configured to receive the second message comprising information about the at least one adopted Tx-Rx for the MUSIM operation and adapt the at least one Tx-Rx for the MUSIM operation, the carrier aggregation and the dual connectivity operation.

The multiple Tx-Rx capability adaptation controller (240b) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210b) is configured to execute instructions stored in the memory (230b) and to perform various processes. The communicator (220b) is configured for communicating internally between internal hardware components and with external devices via one or more networks. The memory (230b) also stores instructions to be executed by the processor (210b). The memory (230b) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230b) may, in some examples, be considered a non-transitory storage medium. The term “non-transitory” may indicate that the storage medium is not embodied in a carrier wave or a propagated signal. However, the term “non-transitory” should not be interpreted that the memory (230b) is non-movable. In certain examples, a non-transitory storage medium may store data that can, over time, change (e.g., in Random Access Memory (RAM) or cache).

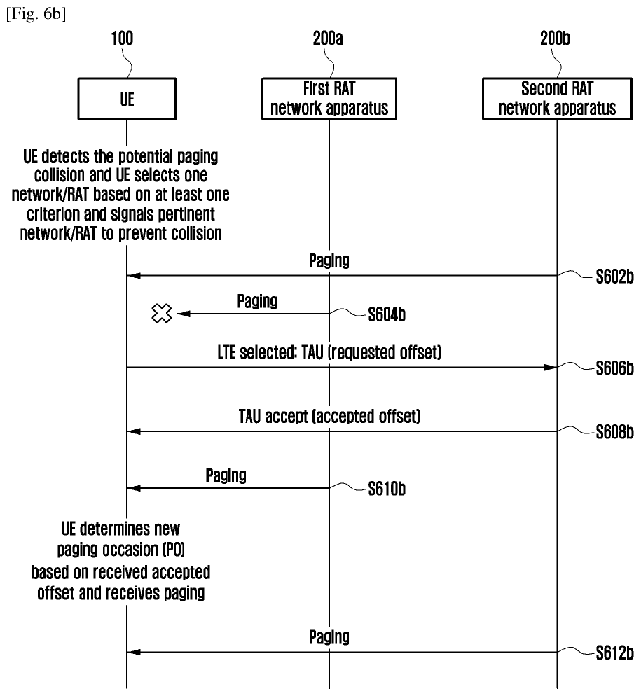

Although the FIG. 6 shows various hardware components of the second RAT network apparatus (200b) but it is to be understood that other embodiments are not limited thereon. In other embodiments, the second RAT network apparatus (200b) may include less or more number of components. Further, the labels or names of the components are used only for illustrative purpose and does not limit the scope of the invention. One or more components can be combined together to perform same or substantially similar function in the first RAT network apparatus (200a).

FIG. 6a is an example sequence diagram illustrating a paging collision avoidance by selecting the RAT network apparatus, wherein the selected RAT network apparatus is a NR apparatus, according to an embodiment as disclosed herein.

At S602a, the second RAT network apparatus (200b) sends the paging to the UE (100). At S604a, the first RAT network apparatus (200a) sends the paging to the UE (100), but not received. The UE (100) detects the potential paging collision and the UE (100) selects one network/RAT based on at least one criterion and signals pertinent network/RAT to prevent collision. At S606a, the UE (100) sends the MRU signalling to the second RAT network apparatus (200b). The selected second RAT network is NR network. At S608a, the second RAT network apparatus (200b) sends the GUTI reassignment to the UE (100) that assigns a new UE_ID to the UE (100). At S610a, the first RAT network apparatus (200a) sends the paging to the UE (100). At S612a, the second RAT network apparatus (200b) sends the paging to the UE (100). The UE (100) determines new paging occasion (PO) based on new UE_ID and receives paging from second RAT network.

FIG. 6b is an example sequence diagram illustrating a paging collision avoidance by selecting the RAT network apparatus, wherein the selected RAT network apparatus is the LTE apparatus, according to an embodiment as disclosed herein.

At S602b, the second RAT network apparatus (200b) sends the paging to the UE (100). At S604b, the first RAT network apparatus (200a) sends the paging to the UE (100). The UE (100) detects the potential paging collision and the UE (100) selects one network/RAT based on at least one criterion and signals pertinent network/RAT to prevent collision. The selected second RAT network is LTE network. At S606b, the UE (100) sends the TAU signalling including the requested offset to the second RAT network apparatus (200b). At S608b, the second RAT network apparatus (200b) sends the TAU accept message including the accepted offset to the UE (100). At S610b, the first RAT network apparatus (200a) sends the paging to the UE (100). At S612b, the second RAT network apparatus (200b) sends the paging to the UE (100). The UE (100) determines new the PO based on received accepted offset and receives paging.

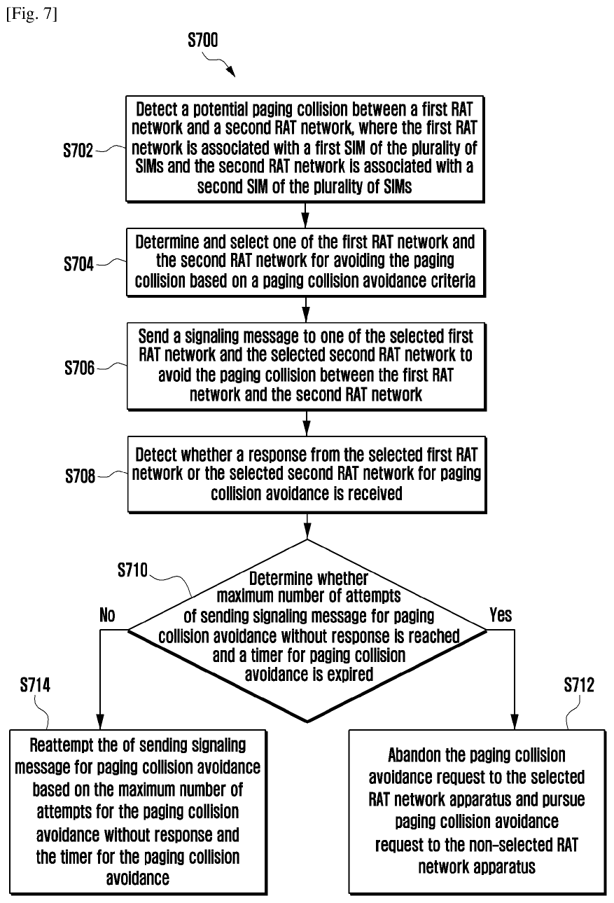

FIG. 7 is a flow chart (S700) illustrating a method, implemented by the UE (100), for the paging collision avoidance, according to an embodiment as disclosed herein. The operations (S702-S714) are handled by the paging collision avoidance controller (140).

At S702, the method includes detecting the potential paging collision between the first RAT network (170a) and the second RAT network (170b). The first RAT network (170a) is associated with the first SIM (160a) and the second RAT network (170b) is associated with the second SIM (170b). At S704, the method includes determining and selecting one of the first RAT network (170a) and the second RAT network (170b) for avoiding the paging collision based on the paging collision avoidance criteria.

At S706, the method includes sending the signalling message to one of the selected first RAT network (170a) and the selected second RAT network (170b) to avoid the paging collision between the first RAT network (170a) and the second RAT network (170b). At S708, the method includes detecting whether the response from the selected first RAT network or the selected second RAT network for paging collision avoidance is received.

At S710, the method includes determining whether the maximum number of attempts of sending signalling message for the paging collision avoidance without response is reached and a timer for the paging collision avoidance request is expired. In response to determining that the maximum number of attempts of sending signaling message for the paging collision avoidance without response is reached and the timer for the paging collision avoidance request is expired then, at S712, the method includes abandon the paging collision avoidance request to the selected RAT network and pursuing the paging collision avoidance request to the non-selected RAT network apparatus (200b).

In response to determining that the maximum number of attempts of sending signaling message for the paging collision avoidance without response is not reached and the timer for the paging collision avoidance request is not expired then, at S714, the method includes reattempting of sending the signalling message for paging collision avoidance based on the maximum number of attempts for the paging collision avoidance without response and the timer for the paging collision avoidance.

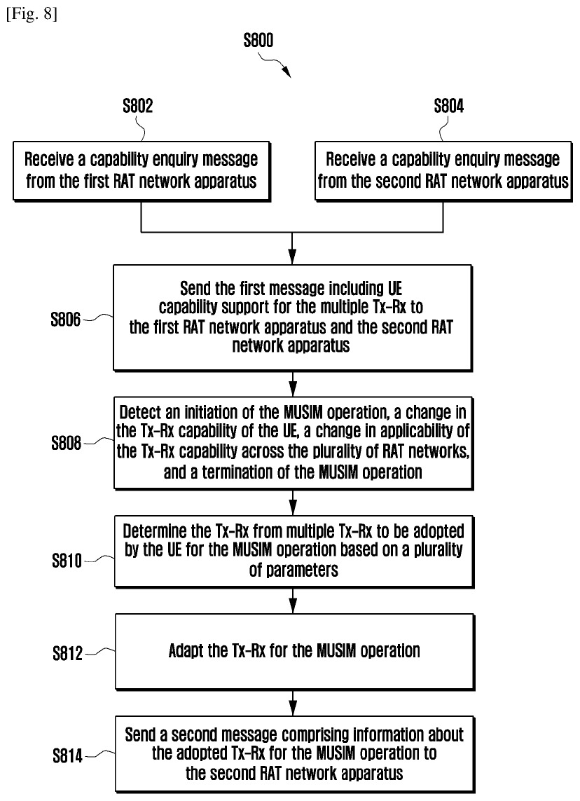

FIG. 8 is a flow chart (S800) illustrating a method, implemented by the UE (100), for dynamic multiple Tx-Rx capability adaptation for the MUSIM operation, according to an embodiment as disclosed herein. The operations (S802-S814) are handled by the multiple Tx-Rx capability adaptation controller (150).

At S802, the method includes receiving the capability enquiry message from the first RAT network apparatus (200a). At S804, the method includes receiving the capability enquiry message from the second RAT network apparatus (200b). At S806, the method includes sending the first message including the UE capability information for the multiple Tx-Rx to the first RAT network apparatus (200a) and the second RAT network apparatus (200b). At S808, the method includes detecting the initiation of the MUSIM operation, the change in the Tx-Rx capability of the UE (100), the change in applicability of the Tx-Rx capability across the plurality of RAT networks (170a and 170b), and the termination of the MUSIM operation.

At S810, the method includes determining the Tx-Rx from multiple Tx-Rx to be adopted by the UE (100) for the MUSIM operation based on the plurality of parameters. At S812, the method includes adapting the Tx-Rx for the MUSIM operation. At S814, the method includes sending the second message comprising information about the adopted Tx-Rx for the MUSIM operation to the second RAT network apparatus (200b).

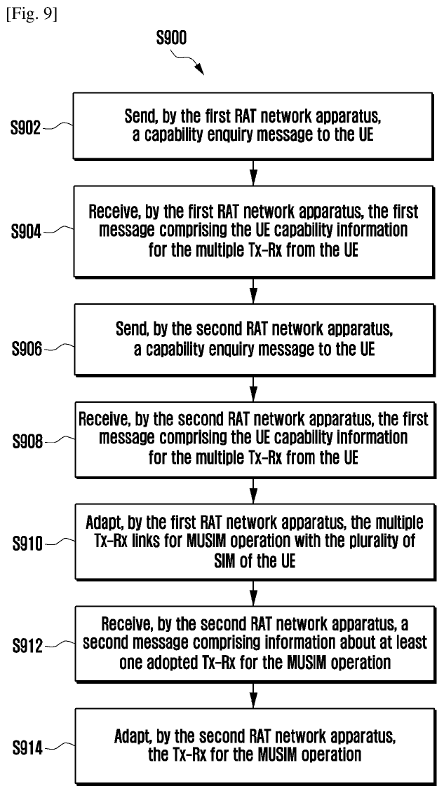

FIG. 9 is a flow chart (S900) illustrating a method, implemented by the first RAT network apparatus (200a) and the second RAT network apparatus (200b), for dynamic multiple Tx-Rx capability adaptation for the MUSIM operation, according to an embodiment as disclosed herein.

At 902, the first RAT network apparatus (200a) sends the capability enquiry message to the UE (200a). At 904, the first RAT network apparatus (200a) receives the first message comprising the UE capability information for the multiple Tx-Rx from the UE (100). At 906, the second RAT network apparatus (200b) sends the capability enquiry message to the UE (100).

At 908, the second RAT network apparatus (200b) receives the first message comprising the UE capability information for the multiple Tx-Rx from the UE (100). At 910, the first RAT network apparatus (200a) adapts the at least one Tx-Rx for the MUSIM operation (170) of the UE (100). At 912, the second RAT network apparatus (200b) receives the second message comprising information about the adopted Tx-Rx for the MUSIM operation. At 914, the second RAT network apparatus (200b) adapts the Tx-Rx for the MUSIM operation.

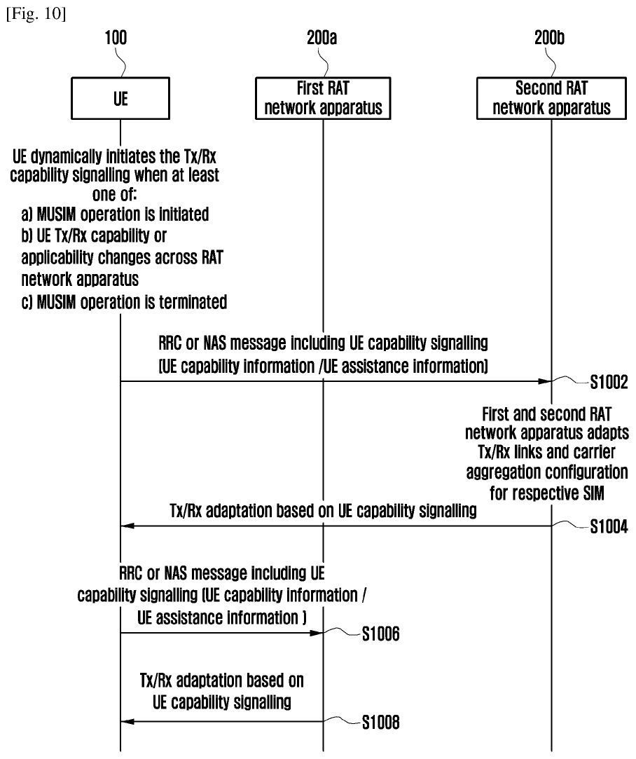

FIG. 10 is a sequence flow diagram illustrating a method for dynamic multiple Tx-Rx capability adaptation for the MUSIM operation, according to an embodiment as disclosed herein.

The UE (100) dynamically initiates the Tx/Rx capability signalling when at least one of: MUSIM operation is initiated, the UE Tx/Rx capability or applicability changes across the RAT network apparatus (200a and 200b), and the MUSIM operation is terminated. At S1002, the UE (100) sends the RRC message or the NAS message including the UE capability signalling to the second RAT network apparatus (200b). The UE capability signalling includes the UE capability information and the UE assistance information. The first RAT network apparatus (200a) and the second RAT network apparatus (200b) adapt the Tx/Rx links and the carrier aggregation configuration for the respective SIM (160a and 160b). At S1004, the second RAT network apparatus 200b sends the Tx/Rx adaptation based on the UE capability signalling. At S1006, the UE (100) sends the RRC message or the NAS message including the UE capability signalling to the first RAT network apparatus (200a). The UE capability signalling includes the UE capability information and the UE assistance information. At S1008, The first RAT network apparatus (200a) sends the Tx/Rx adaptation based on the UE capability signalling to the UE (100).

The various actions, acts, blocks, steps, or the like in the flow charts (S700-S900) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

According to an embodiment, A method for paging collision avoidance by a User Equipment (UE) (100) comprising a plurality of Radio Access Technology (RAT) networks (170) and subscriber identity modules (SIMs) (160) in a wireless cellular network (1000), wherein the method comprises detecting, by the UE (100), a potential paging collision between a first RAT network of the plurality of RAT networks (170) and a second RAT network of the plurality of RAT networks (170), wherein the first RAT network is associated with a first SIM of the plurality of SIMs (160) and the second RAT network is associated with a second SIM of the plurality of SIMs (160), determining and selecting, by the UE (100), one of the first RAT network and the second RAT network for avoiding the paging collision based on a paging collision avoidance criteria, and sending, by the UE (100), a signaling message to one of the selected first RAT network and the selected second RAT network to avoid the paging collision between the first RAT network and the second RAT network.

In some embodiments, the paging collision avoidance criteria comprises at least one of a preferred RAT network, channel conditions of the first RAT network and the second RAT network, a Discontinuous Reception (DRX) cycle length of the first RAT network and the second RAT network, a Radio Resource Control (RRC) state of the UE (100), a concurrent service support at the UE (100), a scheduling pattern, the RAT network associated with the first SIM, a battery power level at the UE (100), a target alignment of a paging occasion (PO) on the first RAT network and the second RAT network, RAT configured by the first RAT network and the second RAT network, a RAT preferred by a user, a RAT specified by standards specification based on information associated with the paging collision avoidance.

In some embodiments, the method further comprises detecting, by the UE (100), whether a response from one of the selected first RAT network and the selected second RAT network for paging collision avoidance is received, determining, by the UE (100), whether at least one of a maximum number of attempts of sending signaling message for the paging collision avoidance without response is reached and a timer for the paging collision avoidance is expired, in response to detecting that the response from one of the selected first RAT network and the selected second RAT network for paging collision avoidance is not received, and performing, by the UE (100), one of: reattempting the sending of signaling message for the paging collision avoidance based on at least one of the maximum number of attempts for the paging collision avoidance without response and the timer for the paging collision avoidance in response to determining that at least one of the maximum number of attempts for the paging collision avoidance without response is not reached and the timer for the paging collision avoidance is not expired, and abandoning the paging collision avoidance to the one of the selected first RAT network and the selected second RAT network and pursuing another paging collision avoidance to one of a non-selected first RAT network and a non-selected second RAT network in response to determining that at least one of the maximum number of attempts of sending signaling message for the paging collision avoidance without response is reached and the timer for the paging collision avoidance is expired.

In some embodiments, the signaling message to the selected RAT network is a Mobility Registration Update (MRU) message when one of the selected first RAT network and the selected second RAT network is New Radio (NR) and a Tracking Area Update (TAU) message including a requested offset when one of the selected first RAT network and the selected second RAT network is LTE network.

In some embodiments, the response comprises one of a GUTI reassignment when one of the selected first RAT network and the selected second RAT network is a New Radio (NR) network apparatus and an accepted offset for an IMSI when one of the selected first RAT network and the selected second RAT network is a LTE network.

In some embodiments, wherein the method further comprises receiving, by the UE (100), at least one of a system information block (SIB) message, a Radio Resource Control (RRC) signaling message, a Non Access Stratum (NAS) signaling message and a paging configuration from one of the selected first RAT network and the selected second RAT network, wherein at least one of the SIB message, the RRC signaling message, the NAS signaling message and the paging configuration comprises at least one of the maximum number of attempts of sending the signaling message for the paging collision avoidance without response and the timer for the paging collision avoidance.

In some embodiments, the RRC signalling message comprises at least one of a RRC release message, a RRC release with suspend configuration message, a RRC release with redirection message, a RRC resume reject message, a handover command message, and a RRC reconfiguration message.

In some embodiments, a scope of the paging collision avoidance is determined based on at least one of a cell wide with cell specific SIB, an area wide with area specific SIB, and a public land mobile network (PLMN) wide with a NAS signalling message.

In some embodiments, an information for the paging collision avoidance is determined based on at least one parameter, wherein the at least one parameter comprises at least one of a RATs of the multiple SIMs (160), a number of SIMs (160), a preferred RAT for paging collision avoidance, a number of Radio Frequency Chains supported, and number of transmission (TX) chains supported.

In some embodiments, the method further comprises configuring, by the UE (100), at least one of the maximum number of attempts of sending the signaling message for the paging collision avoidance request without response and the timer for paging collision avoidance.

According to an embodiment, A User Equipment (UE) (100) for paging collision avoidance in a wireless cellular network (1000), wherein the UE (100) comprises a plurality of Radio Access Technology (RAT) networks (170) and subscriber identity modules (SIMs) (160), a memory (130) storing information about the plurality of RAT networks (170) and the SIMS (160), a processor (110), and a paging collision avoidance controller (140), communicatively coupled to the memory (130) and the processor (110), configured to detect a potential paging collision between a first RAT network of the plurality of RAT networks (170) and a second RAT network of the plurality of RAT networks (170), wherein the first RAT network is associated with a first SIM of the plurality of SIMs (160) and the second RAT network is associated with a second SIM of the plurality of SIMs (160), determine and select one of the first RAT network and the second RAT network for avoiding the paging collision based on a paging collision avoidance criteria, and send a signaling message to one of the selected first RAT network and the selected second RAT network to avoid the paging collision between the first RAT network and the second RAT network.

In some embodiments, the paging collision avoidance criteria comprises at least one of a preferred RAT network, channel conditions of the first RAT network and the second RAT network, a Discontinuous Reception (DRX) cycle length of the first RAT network and the second RAT network, a Radio Resource Control (RRC) state of the UE (100), a concurrent service support at the UE (100), a scheduling pattern, the RAT network associated with the first SIM, a battery power level at the UE (100), a target alignment of a paging occasion (PO) on the first RAT network and the second RAT network, the RAT (170) configured by a network, the RAT (170) preferred by a user, and a RAT specified by standards specification based on information associated with the paging collision avoidance.

In some embodiments, the paging collision avoidance controller (140) is configured to detect whether a response from one of the selected first RAT network and the selected second RAT network for paging collision avoidance is received, determine whether at least one of a maximum number of attempts of sending signaling message for the paging collision avoidance without response is reached and a timer for the paging collision avoidance is expired in response to detecting that the response from one of the selected first RAT network and the selected second RAT network for paging collision avoidance is not received, and perform one of: reattempt the sending of signaling message for paging collision avoidance based on at least one of the maximum number of attempts for the paging collision avoidance without response and the timer for the paging collision avoidance in response to determining that at least one of the maximum number of attempts for the paging collision avoidance without response is not reached and the timer for the paging collision avoidance is not expired, and abandon the paging collision avoidance to one of the selected first RAT network and the selected second RAT network and pursuing another paging collision avoidance to one of non-selected first RAT network and a non-selected second RAT network in response to determining that at least one of the maximum number of attempts of sending signaling message for the paging collision avoidance without response is reached and the timer for the paging collision avoidance is expired.

In some embodiments, the signaling message to the selected RAT network is a Mobility Registration Update (MRU) message when one of the selected first RAT network and the selected second RAT network is New Radio (NR) and a Tracking Area Update (TAU) message including a requested offset when one of the selected first RAT network and the selected second RAT network is LTE network.

In some embodiments, the response comprises one of a GUTI reassignment when one of the selected first RAT network and the selected second RAT network is a New Radio (NR) network apparatus and an accepted offset for an IMSI when one of the selected first RAT network and the selected second RAT network is a LTE network.

In some embodiments, the paging collision avoidance controller (140) is configured to receive at least one of a system information block (SIB) message, a Radio Resource Control (RRC) signaling message, a Non Access Stratum (NAS) signaling message and a paging configuration from one of the selected first RAT network and the selected second RAT network, wherein at least one of the SIB message, the RRC signaling message, the NAS signaling message and the paging configuration comprises at least one of the maximum number of attempts of sending the signaling message for the paging collision avoidance without response and the timer for the paging collision avoidance.

In some embodiments, the RRC signalling message comprises at least one of a RRC release message, a RRC release with suspend configuration message, a RRC release with redirection message, a RRC resume reject message, a handover command message, and a RRC reconfiguration message.

In some embodiments, a scope of the paging collision avoidance is determined based on at least one of a cell wide with cell specific SIB, an area wide with area specific SIB, and a public land mobile network (PLMN) wide with a NAS signalling message.

In some embodiments, an information for the paging collision avoidance is determined based on at least one parameter, wherein the at least one parameter comprises at least one of the RATs (170) of the multiple SIMs (160), a number of SIMs (160), a preferred RAT for paging collision avoidance, a number of Radio Frequency Chains and a number of transmission chains.

In some embodiments, the paging collision avoidance controller (140) is configured to configure at least one of the maximum number of attempts of sending the signaling message for the paging collision avoidance request without response and the timer for paging collision avoidance request.

According to an embodiment, A method for dynamic multiple Transmission-Reception (Tx-Rx) capability adaptation for multi universal subscriber identity module (MUSIM) operation by a User Equipment (UE) (100) comprising a plurality of RAT networks (170) and SIMs (160) in a wireless cellular network (1000), wherein the method comprises sending, by the UE (100), a first message comprising UE capability information for the multiple Tx-Rx to at least one of a first RAT network apparatus (200a) and a second RAT network apparatus (200b), wherein the first RAT network apparatus (200a) is associated with a first SIM of the plurality of SIMs (160) and the second RAT network apparatus (200b) is associated with a second SIM of the plurality of SIMs (160), determining, by the UE (100), at least one Tx-Rx from multiple Tx-Rx to be adopted by the UE (100) for the MUSIM operation based on a plurality of parameters, adapting, by the UE (100), the at least one Tx-Rx for the MUSIM operation, and sending, by the UE (100), a second message comprising information about the at least one adopted Tx-Rx for at least one of the MUSIM operation, a carrier aggregation operation, a dual connectivity operation to the second RAT network apparatus (200b).

In some embodiments, wherein sending, by the UE (100), the first message comprising the UE capability information for the multiple Tx-Rx to the first RAT network apparatus (200a) and the second RAT network apparatus (200b) comprises receiving, by the UE (100), a capability enquiry message from at least one of the first RAT network apparatus (200a) and the second RAT network apparatus (200b), and sending, by the UE (100), the first message comprising the UE capability information for the multiple Tx-Rx to at least one of the first RAT network apparatus (200a) and the second RAT network apparatus (200b).

In some embodiments, wherein sending, by the UE (100), the second message comprising the UE capability information for the multiple Tx-Rx to the at least one of first RAT network apparatus (200a) and the second RAT network apparatus (200b) comprises detecting, by the UE (100), at least one of an initiation of the MUSIM operation, a change in the Tx-Rx capability of the UE (100), a change in applicability of the Tx-Rx capability across the plurality of RAT networks (170), and a termination of the MUSIM operation, and sending, by the UE (100), the second message comprising the UE capability information for the multiple Tx-Rx to the at least one of first RAT network apparatus (200a) and the second RAT network apparatus (200b).

In some embodiments, the first message comprises one of a NAS message, a RRC message, a UE capability information message, and a UE assistance information message, and wherein the second message comprises one of a NAS message, a RRC message, a UE capability information message, and a UE assistance information message.

In some embodiments, the plurality of parameters comprises signal conditions of the first RAT network and the second RAT network, a critical MUSIM operation pursed or not, a concurrent operation pursed or not, multiple SIM operation pursed or not, and a battery status of the UE (100).

In some embodiments, the plurality the MUSIM operation comprises a change of a RRC state, an initiation of a service, a termination of service and handle of at least one activity comprising a paging reception, SIB reception, and Radio resource management (RRM) measurement, and the plurality of carrier aggregation and dual connectivity operation comprises at least one of activation, deactivation, release and addition of a Secondary Cell (SCell) or a Secondary Cell Group (SCG).

According to an embodiment, A method for dynamic multiple Transmission-Reception (Tx-Rx) capability adaptation for multi universal subscriber identity module (MUSIM) operation by a User Equipment (UE) (100) comprising a plurality of RAT networks (170) and SIMs (160) in a wireless cellular network (1000), wherein the method comprises receiving, by a first RAT network apparatus (200a) and a second RAT network apparatus (200b), a first message comprising UE capability information for the multiple Tx-Rx from the UE (100), wherein the first RAT network apparatus (200a) is associated with a first SIM of the plurality of SIMs (160) and the second RAT network apparatus (200b) is associated with a second SIM of the plurality of SIMs (160), adapting, by the first RAT network apparatus (200a), the at least one Tx-Rx for the MUSIM operation of the UE (100), receiving, by the second RAT network apparatus (200b), a second message comprising information about at least one adopted Tx-Rx for the MUSIM operation, and adapting, by the second RAT network apparatus (200b), the at least one Tx-Rx for the at least one of the MUSIM operation, a carrier aggregation operation and a dual connectivity operation.

In some embodiments, wherein receiving, by the first RAT network apparatus (200a), the first message comprising the UE capability information for the multiple Tx-Rx from the UE (100) comprises sending, by the first RAT network apparatus (200a), a capability enquiry message to the UE (100), and receiving, by the first RAT network apparatus (200a), the first message comprising the UE capability information for the multiple Tx-Rx from the UE (100).

In some embodiments, wherein receiving, by the second RAT network apparatus (200b), the first message comprising the UE capability information for the multiple Tx-Rx from the UE (100) comprises sending, by the second RAT network apparatus (200b), a capability enquiry message to the UE (100), and receiving, by the second RAT network apparatus (200b), the first message comprising the UE capability information for the multiple Tx-Rx from the UE (100).

In some embodiments, the first message comprises one of a NAS message, a RRC message, a UE capability information message, and a UE assistance information message, and wherein the second message comprises one of a NAS message, a RRC message, a UE capability information message, and a UE assistance information message.

According to an embodiment, A User Equipment (UE) (100) for dynamic multiple Transmission-Reception (Tx-Rx) capability adaptation for multi universal subscriber identity module (MUSIM) operation in a wireless cellular network (1000), wherein the UE (100) comprises a plurality of Radio Access Technology (RAT) networks (170) and subscriber identity modules (SIMs) (160), a memory (130) storing information about the plurality of RAT networks (170) and the SIMS (160), a processor (110), and a multiple Tx-Rx capability adaptation controller (150), communicatively coupled to the memory (130) and the processor (110), configured to send a first message comprising UE capability information for the multiple Tx-Rx to a first RAT network apparatus (200a) and a second RAT network apparatus (200b), wherein the first RAT network apparatus (200a) is associated with a first SIM of the plurality of SIMs (160) and the second RAT network apparatus (200b) is associated with a second SIM of the plurality of SIMs (200b), determine at least one Tx-Rx from multiple Tx-Rx to be adopted by the UE (100) for the MUSIM operation based on a plurality of parameters, adapt the at least one Tx-Rx for the MUSIM operation, and send a second message comprising information about the at least one adopted Tx-Rx for the MUSIM operation to the second RAT network apparatus (200b).

In some embodiments, wherein send the first message comprising UE capability information for the multiple Tx-Rx to the first RAT network apparatus (200a) and the second RAT network apparatus (200b) comprises receive a capability enquiry message from the first RAT network apparatus (200a) and the second RAT network apparatus (200b), and send the first message comprising the UE capability information for the multiple Tx-Rx to the first RAT network apparatus (200a) and the second RAT apparatus (200b).

In some embodiments, wherein send the second message comprising UE capability information for the multiple Tx-Rx to the first RAT network apparatus (200a) and the second RAT network apparatus (200b) comprises detect at least one of an initiation of the MUSIM operation, a change in the Tx-Rx capability of the UE (100), a change in applicability of the Tx-Rx capability across the plurality of RAT networks (170), and a termination of the MUSIM operation and send the second message comprising UE capability information for the multiple Tx-Rx to the first RAT network apparatus (200a) and the second RAT network apparatus (200b).

In some embodiments, the first message comprises one of a NAS message, a RRC message, a UE capability information message, and a UE assistance information message, and wherein the second message comprises one of a NAS message, a RRC message, a UE capability information message, and a UE assistance information message.

In some embodiments, the plurality of parameters comprises signal conditions of the first RAT network apparatus (200a) and the second RAT network apparatus (200b), a critical MUSIM operation pursed or not, a concurrent operation pursed or not, multiple SIM operation pursed or not, and a battery status of the UE (100).

In some embodiments, the plurality the MUSIM operation comprises a change of a RRC state, an initiation of a service, a termination of service and handle of at least one activity comprising a paging reception, SIB reception, and Radio resource management (RRM) measurement and the plurality of carrier aggregation and dual connectivity operation comprises at least one of activation, deactivation, release and addition of a Secondary Cell (SCell) or a Secondary Cell Group (SCG).

According to an embodiment, A wireless cellular network (1000) for dynamic multiple Transmission-Reception (Tx-Rx) capability adaptation for multi universal subscriber identity module (MUSIM) operation, wherein the wireless cellular network (1000) comprises a User Equipment (UE) (100) comprising a plurality of RAT networks (170) and SIMs (160) a first RAT network apparatus (200a) connected to the UE (100), wherein the first RAT network apparatus (200a) comprises a memory (230a) storing information about the plurality of RAT networks and the SIMS, a processor (210a), and a multiple Tx-Rx capability adaptation controller (240a), communicatively coupled to the memory (230a) and the processor (210a), configured to receive a first message comprising UE capability information for the multiple Tx-Rx from the UE (100), wherein the first RAT network apparatus (200a) is associated with a first SIM of the plurality of SIMs (160) and the second RAT network apparatus (200b) is associated with a second SIM of the plurality of SIMs (160) adapt the at least one Tx-Rx for the MUSIM operation of the UE (100), and a second RAT network apparatus (200b) connected to the UE (100), wherein the second RAT network apparatus (200b) comprising a memory (230b) storing information about the plurality of RAT networks and the SIMS, a processor (210b), and a multiple Tx-Rx capability adaptation controller (240b), communicatively coupled to the memory (230b) and the processor (210b), configured to receive a second message comprising information about at least one adopted Tx-Rx for the MUSIM operation, and adapt the at least one Tx-Rx for the MUSIM operation, a carrier aggregation and a dual connectivity operation.

In some embodiments, wherein receive the first message comprising the UE capability information for the multiple Tx-Rx from the UE (100) comprises send a capability enquiry message to the UE (100), and receive the first message comprising the UE capability information for the multiple Tx-Rx from the UE (100).

In some embodiments, the first message comprises one of a NAS message, a RRC message, a UE capability information message, and a UE assistance information message, and wherein the second message comprises one of a NAS message, a RRC message, a UE capability information message, and a UE assistance information message.

1-15. (canceled)

16. A method for paging collision avoidance performed by a User Equipment (UE) comprising a plurality of subscriber identity modules (SIMs) in a wireless cellular network, the method comprising:
determining a potential paging collision between a first radio access technology (RAT) network of a plurality of RAT networks and a second RAT network of the plurality of RAT networks, wherein the first RAT network is associated with a first SIM of the plurality of SIMs and the second RAT network is associated with a second SIM of the plurality of SIMs;
transmitting, to one of the first RAT network or the second RAT network, a signaling message to avoid the paging collision between the first RAT network and the second RAT network.

17. The method of claim 16, further comprising:
selecting one of the first RAT network or the second RAT network, and
wherein the signaling message is transmitted to selected RAT network.

18. The method of claim 16, wherein the selecting is performed based on a paging collision avoidance criteria, and
wherein the paging collision avoidance criteria comprises at least one of a preferred RAT network, channel conditions of the first RAT network and the second RAT network, a Discontinuous Reception (DRX) cycle length of the first RAT network and the second RAT network, a Radio Resource Control (RRC) state of the UE, a concurrent service support at the UE, a scheduling pattern, the RAT network associated with the first SIM, a battery power level at the UE, a target alignment of a paging occasion (PO) on the first RAT network and the second RAT network, RAT configured by the first RAT network and the second RAT network, a RAT preferred by a user, or a RAT specified by standards specification based on information associated with the paging collision avoidance.

19. The method of claim 16,
wherein the signaling message is a Mobility Registration Update (MRU) message.

20. The method of claim 19, further comprising:
receiving, from one of the first RAT network or the second RAT network, a response message corresponding to the signaling message,
wherein the response message includes a globally unique temporary identifier (GUTI).

21. The method of claim 16,
wherein the signaling message is a tracking area update (TAU) message.

22. The method of claim 21, further comprising:
receiving, from one of the first RAT network or the second RAT network, a response message corresponding to the signaling message,
wherein the response message includes an accepted international mobile subscriber identity (IMSI) offset value.

23. A user equipment (UE) comprising a plurality of subscriber identity modules (SIMs) in a wireless cellular network, the UE comprising:
a transceiver; and
a controller coupled with the transceiver and configured to:
determine a potential paging collision between a first radio access technology (RAT) network of a plurality of RAT networks and a second RAT network of the plurality of RAT networks, wherein the first RAT network is associated with a first SIM of the plurality of SIMs and the second RAT network is associated with a second SIM of the plurality of SIMs,
transmitting, to one of the first RAT network or the second RAT network, a signaling message to avoid the paging collision between the first RAT network and the second RAT network.

24. The UE of claim 23,
wherein the controller is further configured to:
select one of the first RAT network or the second RAT network,
wherein the signaling message is transmitted to selected RAT network.

25. The UE of claim 23,
wherein the selection is performed based on a paging collision avoidance criteria, and
wherein the paging collision avoidance criteria comprises at least one of a preferred RAT network, channel conditions of the first RAT network and the second RAT network, a Discontinuous Reception (DRX) cycle length of the first RAT network and the second RAT network, a Radio Resource Control (RRC) state of the UE, a concurrent service support at the UE, a scheduling pattern, the RAT network associated with the first SIM, a battery power level at the UE, a target alignment of a paging occasion (PO) on the first RAT network and the second RAT network, RAT configured by the first RAT network and the second RAT network, a RAT preferred by a user, or a RAT specified by standards specification based on information associated with the paging collision avoidance.

26. The UE of claim 23,
wherein the signaling message is a Mobility Registration Update (MRU) message.

27. The UE of claim 26,
wherein the controller is further configured to:
receive, from one of the first RAT network or the second RAT network, a response message corresponding to the signaling message,
wherein the response message includes a globally unique temporary identifier (GUTI).

28. The UE of claim 23,
wherein the signaling message is a tracking area update (TAU) message.

29. The UE of claim 28,
wherein the controller is further configured to:
receive, from one of the first RAT network or the second RAT network, a response message corresponding to the signaling message,
wherein the response message includes an accepted international mobile subscriber identity (IMSI) offset value.
